(19) United States
(12) Patent Application Publication
(10) Pub. No.: US 2006/0032418 A1
(43) Pub. Date: Feb. 16, 2006

(54) Manual override for use with an electric safe

(75) Inventor: Mike Smith, Scottsburg, IN (US)

Correspondence Address: BROOKS KUSHMAN P.C., 1000 TOWN CENTER, TWENTY-SECOND FLOOR, SOUTHFIELD, MI, 48075, US

(73) Assignee: Fireking International, New Albany, IN (US)

(21) Appl. No.: 10/917,567

(22) Filed: Aug. 13, 2004

(51) Int. Cl. E05G 1/04; E05B 47/00

(52) U.S. Cl. 109/59 R; 70/279.1

(57) ABSTRACT

A manual override system for use with an electric safe. The manual override system permitting the safe to be opened in the event that an electrical system failure or other fault prevents controlling an electric lock. The manual override includes a slide plate and a mechanical lock connected to the slide plate. The electric lock is mounted to the slide plate such that it is moveable with movement of the slide plate. The manual lock is configured to move the slide plate, and thereby the electric lock, so as to permit the safe to be opened in the event of the electrical system failure or other fault prevents controlling the electric lock.

### BACKGROUND OF THE INVENTION

1. Field of the Invention

The present invention relates to safes having electric locks for locking the safe, and in particular, to systems for use with such safes that permit manually overriding the electrical lock, such as if an electrical failure prohibits unlocking the electric lock.

2. Background Art

With the advent of new technologies, more and more safes are configured with electric locks. The electric locks are advantageous because they can be controlled remotely over networks and other communication mediums to electrically control the unlocking and locking of the safe.

One problem with electric locks is that the electric lock automatically locks if power or other electrical failures or faults occur in the system. This is a problem because the lock remains locked until the problem is fixed. As such, the contents stored within the safe are locked therein until the electrical problem is fixed or until the safe is drilled open and the lock replaced.

The inability to unlock the electric lock until the electric fault is corrected is disadvantageous for a number of reasons, and namely because the user may need to immediately secure items within the safe. In addition, drilling into the lock is also disadvantageous for a number of reasons, and namely because it requires subsequent repair of the portion of the safe drilled through.

One solution to these problems is to provide a manual override that permits the safe to be unlocked even if the electrical fault occurs. In general, such manual overrides require complex release mechanisms and integration within the electrical system of the electric locks.

### SUMMARY OF THE INVENTION

It is, therefore, an object of the present invention to provide a manual override system for a safe having an electric lock that is relatively simple in design and preferably one that is cost effective and requires, if any, minimal integration with an electric lock.

The present invention contemplates a number of features for the manual override system, including a slide plate mounted to the safe, an electric lock mounted on the slide plate such that the electric lock moves with movement of the slide plate, and a mechanical lock in communication with the slide plate and configured to move the slide plate to a released position in which the electric lock is unable to lock the safe door if the mechanical lock is unlocked.

The system can further include a release mechanism configured for actuation by a user to open the safe door. Preferably, the electric lock obstructs operation of the release mechanism if power is lost to the electric lock such that thereafter, the mechanical lock is operable to move the slide plate to the released position to overcome the obstruction provided by the electric lock, permitting the release mechanism can be actuated to open the door.

The locking mechanism can include a handle on an outside of the safe door and a yoke on an inside of the safe door such that the yoke is moveable by the handle for positioning a locking bolt of the door safe in a locked position to lock the door and an unlocked position to unlock the door. With this configuration, the movement of the slide plate to the released position is sufficient to prevent a swing bolt of the electric lock from obstructing the locking bolt.

The system can further include a tensioning member configured to bias against movement of the slide plate such that the tensioning member moves the slide plate from the released position to the lock position after unlocking the mechanical lock.

The mechanical lock can be a dial combination lock configured to overcome the biasing provided by the tensioning member such that the slide plate remains in the released position until a dial of the dial combination lock is released. In this manner, the released dial permits the slide plate to move back to the locked position wherein the electric lock again locks the safe such that the mechanical lock can be used to repeatedly unlock and lock the safe even if power is lost to the electric lock.

### BRIEF DESCRIPTION OF THE DRAWINGS

FIG. 1 illustrates an electric safe in accordance with one aspect of the present invention;

FIG. 2 illustrates a portion of the electric safe with a slide plate in a locked position in accordance with one aspect of the present invention;

FIG. 3 illustrates a portion of the electric safe with the slide plate in an unlocked position in accordance with one aspect of the present invention;

FIG. 4 illustrates a backside view of the slide plate in accordance with one aspect of the present invention; and

FIG. 5 illustrates a cross-section view taken along line 5-5 of FIG. 3 in accordance with one aspect of the present invention.

### DETAILED DESCRIPTION OF THE PREFERRED EMBODIMENT(S)

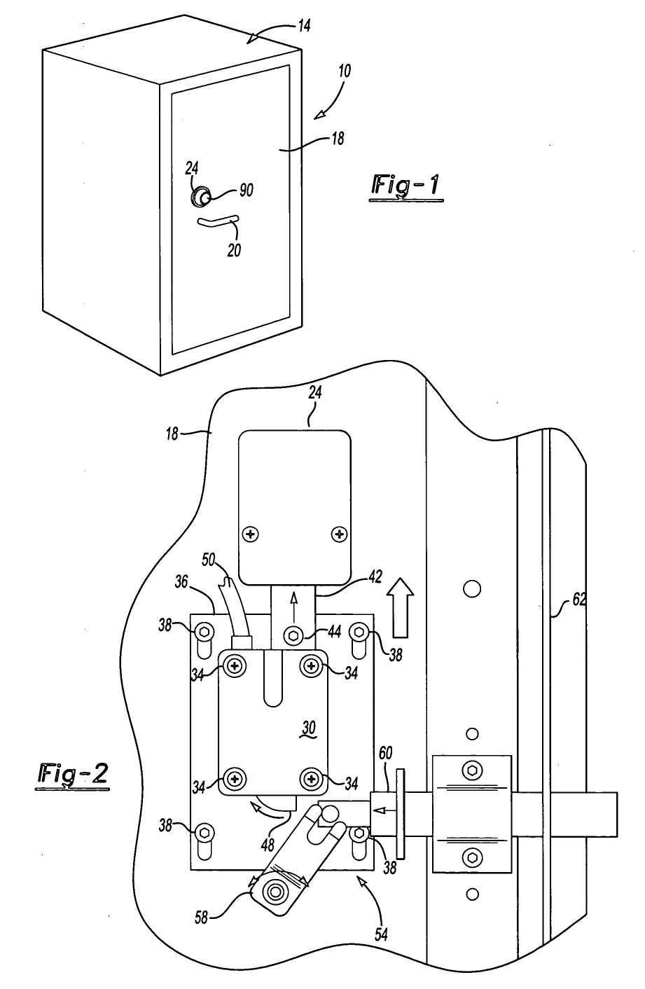

FIG. 1 illustrates an electric safe 10 in accordance with one aspect of the present invention. The safe 10 includes a housing 14 and a door 18 covering an interior portion of the housing 14 where items can be stored for safekeeping. The door 18 can be opened by actuating a handle 20 on the outside of the housing 14 so as to permit access to the items stored therein. As described below in more detail, a mechanical lock 24 is provided on the outside of the door.

The safe 10 shown in FIG. 1 is intended to describe any safe having an opening to an interior portion that is covered with the door 18 or other feature to protect items stored therein. As such, this exemplary illustration is not intended to limit the scope and contemplation of the present invention. Rather, the present invention contemplates that the safe 10 may include any number of configurations and features for storing items therein.

FIG. 2 illustrates a partial view of an inside portion of the door 18 behind the mechanical lock 24 and the handle 20. As shown, the safe 10 further includes an electric lock 30 mounted by fasteners 34 to a slide plate 36, which in turn in mounted by fasteners 38 to the door 18 and connected by a linkage 42 and a fastener 44 to the mechanical lock 24, in accordance with one aspect of the present invention.

The electric lock 30 includes a swing bolt 48 that swings in the direction indicated by the arrow when an appropriate signals is received over an electrical cable 50, such as over a cable from a computer or from a key-pad on the outside of the door. The movement of the swing bolt 48 allows a locking mechanism 54 of the door 18 to be opened. In particular, the locking mechanism 54 preferably refers to the operation of the handle 20 with a yoke 58 connected to the handle 20 and a locking bolt 60 such that the handle 20 can be turned to cause the yoke 58 to move in the direction indicated by the arrow and the locking bolt 60 in the direction indicated by the arrow.

As shown, the locking bolt 60 is in a locked position such that it extends into a door jam 62 on the housing 14 to prevent the door 18 from being opened. If the locking bolt 60 is permitted to move in the direction of the arrow, it can be retracted laterally to remove it from the door jam 62, thereby permitting the door 18 to be opened and the items stored in the safe 10 to be accessed. Optionally, the electric lock 30 can be configured such that the swing bolt 48 is released, as opposed to swinging in the direction of the arrow, such that the lateral motion of the locking bolt 60 in the direction of the arrow causes the locking bolt 60 to move the swing bolt 48 in the direction of the arrow.

When locked, the electric lock 30 prevents movement of the swing bolt 48 such that it obstructs the locking bolt 60. In this manner, the safe 10 is locked and the locking bolt 60 is prevented from being retracted to open the door 18. If the electric lock 30 is unlocked, the swing bolt 42 is moved in the direction of the arrow, either automatically by the electric lock 30 or by the locking bolt 60, such that the locking bolt 60 can be retracted to permit opening of the safe door 18.

In the event of an electrical system failure, power loss, or other fault that prevents unlocking the electric lock 30, the electric lock 30 automatically defaults to the locked position, i.e. the swing bolt 48 is fixed in its obstructing position to prohibit retraction of the locking bolt 60. In accordance with one aspect of the present invention, the mechanical lock 24 can be used to override the electric lock 30 so that the safe 10 can be unlocked in the event of such an electric interrupt or failure.

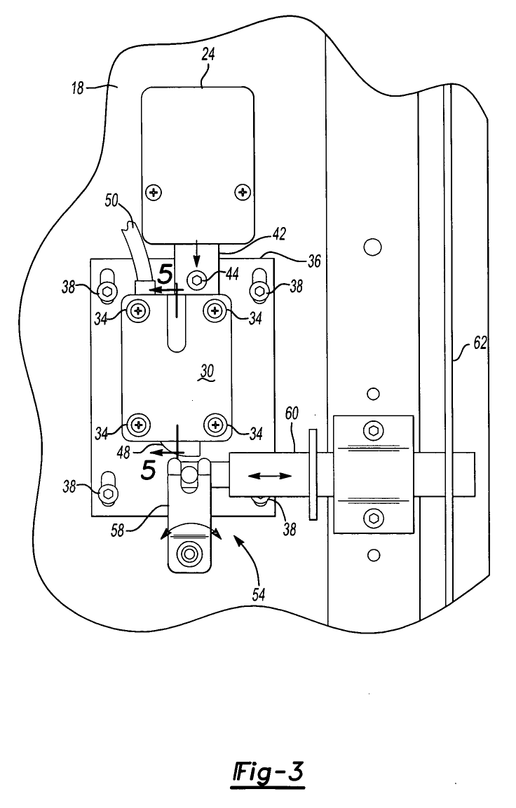

FIG. 3 illustrates the mechanical lock 24 acting as a manual override to unlock the safe 10 in the event that the electric lock 30 is inactive, in accordance with one aspect of the present invention. As shown, the slide plate 36 to which the electric lock 30 is mounted, is moved to an unlocked or releases position. This position is offset generally in a vertical position relative the position of the slide plate 36 shown in FIG. 2, which is in a locked position.

The slide plate 36 is moved to the unlocked position by way of the mechanical lock 24. In particular, the mechanical lock 24 pulls on the linkage 42 connected therebetween such that the slide plate 36, and thereby the electric lock 30, is pulled upwardly away from the locking mechanism 54. In this position, which is shown in FIG. 3, the swing bolt 48 of the electric lock 30 is raised above the locking bolt 60 such that the locking bolt 60 can be retracted by turning the handle 20. Because the operation of the handle 20 is not controlled by an electrical system, the user is free to retract the locking bolt 60 to an unlocked position whereby the locking bolt 60 is removed from the door jam 62 and the door 18 is free to open.

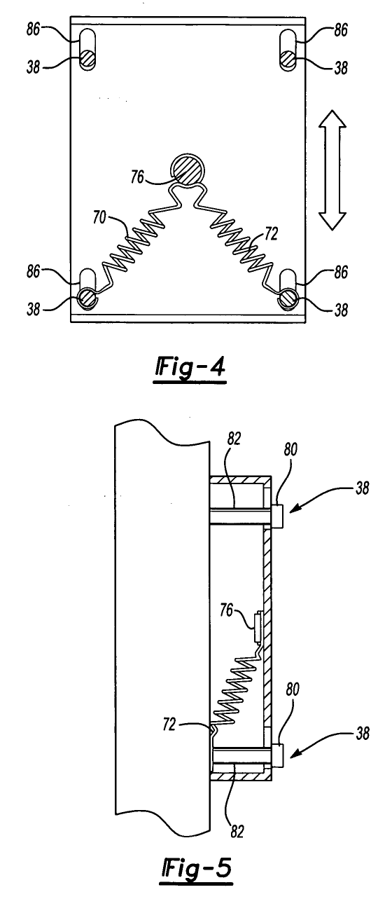

FIG. 4 illustrates a backside view of the slide plate 36 in accordance with one aspect of the present invention. From this view, tension members 70 and 72 connected between a protrusion 76 on the backside of the slide plate 36 and each of the fasteners 38 at the lower end of the slide plate 36 are shown. The tensioning members 70 and 72 are preferably springs, however they may be other items, that provide biasing force against the upwardly movement of the slide plate 36. In operation, the biasing force provided by the tensioning members 70 and 72 is sufficient to retract the slide plate 36 from the unlocked position to the locked position so that the swing bolt 48 is again positioned to obstruct the locking bolt 60, and thereby, to permit re-locking of the safe 10.

FIG. 5 illustrates a cross-section view of the slide plate 36 taken along line 5-5 of FIG. 3. As shown, the slide plate 36 is in the unlocked position and the tensioning member 72 is tending to pull the slide plate 36 back to the locked position. The tensioning member 72 is shown as connected from the protrusion 76 located at a central portion of the slide plate 36 to the lower fastener 38. The present invention, however, is not so limited, and in particular, it contemplates that the tensioning members 70 and 72 may be connected to other items and the system may include other features.

The fasteners 38 used to secure the slide plate 36 to the door 28 include a cap portion 80 and a body portion 82. The body portion 82 is smaller in diameter than the cap portion 80 so that the slide plate 36, and in particular a number of aperture slide grooves 86 in the slide plate 36, are free to move about the fasteners 38 so as to permit the mechanical lock 24 to move the slide plate 36 from the locked position (FIG. 2) to the unlocked position (FIG. 3).

In accordance with one aspect of the present invention, the mechanical lock, as shown in FIG. 1, is preferably a manually operated dial combination lock having a dial 90 on the outside portion of the safe 10. The dial 90 can be turned to specific combination to unlock the mechanical lock 24, as one having ordinary skill in the art will appreciate. Rather than unlocking a lock, such as by releasing a lock, the mechanical lock 24 of the present invention is configured to pull on the linkage 42 so as to retract the slide plate 36 to the unlocked position.

Still further, the mechanical lock 24 is preferably configured to maintain the slide plate 36 in the unlocked position so long as the dial 90 has not be released. In other words, when turning the dial 90 to dial in the appropriate combination, the user is applying force to the dial 90. In accordance with the present invention, this force, or torque on the dial 90, is used to retain the linkage 42 in the upward, or unlocked, position shown in FIG. 3. Should the user remove their hand from the dial 90, or otherwise release the torque, the biasing force of the tensioning members 70 and 72 is sufficient to retract the slide plate, and thereby the linkage 42, to the downward, or locked, position shown in FIG. 2. In this manner, and even in the event of an electrical fault, or without an electrical fault, the mechanical lock 24 can be used to move the slide plate 36 between the locked and unlocked position so as to permit unlocking and locking of the safe 10. This process can be repeated as often as desired such that the safe is fully functional, at least in so far as being accessible, regardless of whether the electric lock 30 is operational.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A safe, the safe comprising:
a slide plate;
an electric lock mounted on the slide plate such that the electric lock moves with movement of the slide plate, the electric lock configured to lock a door of the safe if the slide plate is in a locked position; and
a mechanical lock in communication with the slide plate and configured to move the slide plate to a released position in which the electric lock is unable to lock the safe door if the mechanical lock is unlocked.

2. The safe of claim 1 further comprising a release mechanism configured for actuation by a user to open the safe door, wherein the electric lock obstructs operation of the release mechanism if power is lost to the electric lock.

3. The safe of claim 2 wherein the mechanical lock is operable to move the slide plate to the released position if power is lost, the movement of the slide pate to the released position being sufficient to overcome the obstruction provided by the electric lock so that the release mechanism can be actuated to open the door.

4. The safe of claim 3 wherein the release mechanism includes a handle on an outside of the safe door and a yoke on an inside of the safe door, the yoke moveable by the handle for positioning a locking bolt of the door safe, the locking bolt positionable in a locked position to lock the door and an unlocked position to unlock the door.

5. The safe of claim 4 wherein the electric lock obstructs movement of the locking bolt if power is lost.

6. The safe of claim 5 wherein the electric lock includes a swing bolt for obstructing the locking bolt.

7. The safe of claim 6 wherein the movement of the slide plate to the released position is sufficient to prevent the swing bolt from obstructing the locking bolt.

8. The safe of claim 1 further comprising a tensioning member configured to bias against movement of the slide plate such that the tensioning member moves the slide plate from the released position to the lock position after unlocking the mechanical lock.

9. The safe of claim 8 wherein the mechanical lock is a dial combination lock.

10. The safe of claim 9 wherein the dial combination lock is configured to overcome the biasing provided by the tensioning member such that the slide plate remains in the released position until a dial of the dial combination lock is released.

11. The safe of claim 10 wherein the released dial permits the slide plate to move back to the locked position wherein the electric lock locks the safe such that the mechanical lock can be used to repeatedly unlock and lock the safe even if power is lost to the electric lock.

12. The safe of claim 8 wherein the tensioning member is a spring.

13. The safe of claim 8 further comprising at least one fastener mounted to the door for supporting the slide plate and configured to permit the slide plate to move about the fastener between the locked and released positions.

14. The safe of claim 13 wherein five fasteners are mounted to the door and the slide plate includes four corners, wherein four of the five fasteners are positioned proximate the four corners and one of the five fasteners is position proximate a central portion of the slide plate.

15. The safe of claim 14 wherein the tensioning member is connected between one of the four corner fasteners and the central portion fastener.

16. The safe of claim 13 wherein the at least one fastener is a cap screw have a cap portion and a body portion, the body portion having a smaller diameter than the cap portion such that the body portion fits through an aperture in the slide plate and the cap portion covers a portion of the aperture to mount the slide plate to the door so as to permit the slide plate to move about the fastener.

17. A manual override system for a safe having an electric lock that permits the safe to be repeatedly unlocked and locked if an electrical failure prohibits unlocking the electric lock, the system comprising:
a slide plate on which the electric lock is mounted such that the electric lock moves with movement of the slide plate; and
a mechanical lock in communication with the slide plate to move the slide plate between a locked position and an unlocked position, the locked position positioning the electric lock to obstruct a locking mechanism used to lock the safe so as to prevent unlocking of the safe if the mechanical lock is locked, the unlocked position positioning the electric lock to not obstruct the locking mechanism so as to permit unlocking of the safe if the mechanical lock is unlocked, wherein the mechanical lock can be repeatedly unlocked and locked to permit locking and unlocking of the safe even if the electrical failure prohibits unlocking the electric lock.

18. The system of claim 17 further comprising a tensioning member configured to bias against movement of the slide plate such that the tensioning member moves the slide plate from the unlocked position to the locked position after unlocking the mechanical lock.

19. The system of claim 18 wherein the mechanical lock is a dial combination lock configured to overcome the biasing provided by the tensioning member such that the slide plate remains in the released position until a dial of the dial combination lock is released.

20. The system of claim 19 wherein the released dial permits the tensioning member to move the slide plate from the unlocked position back to the locked position.

21. A safe, the safe comprising:
an electric lock having an electronic actuator for electronically actuating a locking feature used to lock a door of the safe;
a slide plate configured to secure the electric lock; and
a mechanical lock in communication with the slide plate and configured to move the slide plate to a released position in which the electric lock is unable to lock the safe door, the slide plate causing both of the electronic actuator and locking feature to move.

22. The safe of claim 21 wherein the locking feature is a swing bolt.

23. The safe of claim 21 wherein the mechanical lock is a combination lock having a rotary dial, wherein the slide plate is configured to move with rotation of the dial.

24. The safe of claim 23 wherein the slide plate is configured to return to an unreleased position if pressure is removed from the rotary dial after the slide plate is moved to the released position.
